(19) United States
(12) Patent Application Publication
(10) Pub. No.: US 2003/0194542 A1
(43) Pub. Date: Oct. 16, 2003

(54) Panel with injection molded components and method of making same

(75) Inventor: Rob E. Springer, Port Sheldon, MI (US)

Correspondence Address: FOLEY & LARDNER, 777 EAST WISCONSIN AVENUE, SUITE 3800, MILWAUKEE, WI, 53202-5308, US

(73) Assignee: Johnson Controls Technology Company

(21) Appl. No.: 10/120,892

(22) Filed: Apr. 11, 2002

(51) Int. Cl. B32B 3/14

(52) U.S. Cl. 428/221

(57) ABSTRACT

A product and a method of making it are disclosed. In the illustrated embodiment, the product is a door trim panel for a vehicle which includes an inner surface for facing a vehicle interior and an outer or “B” surface facing the inside of a vehicle door. Various components typically found on the “B” surface of the door trim panel are added to the panel in the present invention by a molding process. The components are preferably formed from a thermoplastic, and the door trim panel itself comprises a fiber or thermoplastic panel capable of forming a mechanical or a fusion bond with the components. Examples of the components which may be added to a panel using the present invention include locators, ribs or other reinforcement members, attachments for wire harnesses, supports, doghouses, flanges, etc. It is also desirable to use recycled material in the panel.

Cross-reference to related patent applications, if any: None.

### BACKGROUND OF THE INVENTION

1. Field of the Invention

The present invention relates generally to the field of molded products and more particularly to the injection molding of certain components to and at least one surface of a panel. In its most preferred form, the present invention relates to panels used in vehicles (e.g. door or other interior trim panels) and the attachment of various components to the panels by including thermoplastic resins in the components and providing thermoplastic material or a porous surface on the panel. In the most preferred method, the components are added to the panel after the panel has been thermoformed.

2. Description of the Prior Art

A large number of patents and other prior art documents relate to the general field of molding. Thermoplastic resins are frequently used, and final products can result from two or more molding steps or may contain two or more resins. These processes may be known under a variety of names, such as co-molding, over-molding, insert-molding, etc.

It is also well known that recycled thermoplastic can be used in molding operations, and such recycled materials may come from a variety of sources, such as beverage bottles, returnable plastic crates, and certain vehicle components, especially headliners. The material is usually, but need not be limited to, polyethylenterepthalate (PET), polyethylenes, polypropylenes, and other known and preferably inexpensive, non-toxic and tough resins which can be melted or softened during fabrication, and which then cool to a stable state over the anticipated range of temperatures to be encountered during use of the fabricated product.

In connection with the use of recycled materials, in molded form, vehicle arm rests are shown in U.S. Pat. No. 5,551,755 issued Sep. 3, 1996 to Lindberg for “Padded Article.”

An “Impact Absorption Member” is shown in U.S. Pat. No. 5,884,962 issued to Mattingly on Mar. 23, 1999. This patent shows thermoformed materials in a sinusoidal pattern used as an impact countermeasure, e.g., in vehicle “A” pillars.

The use of recycled thermoformable materials to prepare vehicle panels is discussed in considerable detail in U.S. Pat. No. 5,879,802 issued Mar. 9, 1999 to Beard et al. for “Vehicle Panel Member.” This patent, the entire disclosure of which is incorporated into this specification by this reference, describes a mixture of recycled, reground thermoformable material mixed with reprocessed headliner materials which include fibers and thermosetting resins. They are combined, mixed, carded and heated, and thereafter shaped into vehicle panels. The resulting panels can be used as impact absorption devices or for other vehicle panels such as headliners or door panels. The resulting panel of the process of this patent will hereinafter be referred to as a “panel such as that described in the aforementioned '802 patent.”

The use of natural or synthetic fibers in vehicle panels is discussed in Haussling's U.S. Pat. Nos. 4,828,910 and 5,068,001 issued respectively on May 9, 1989 and Nov. 26, 1991. The natural fibers can be jute, flax, kenaf, hemp and sisal. Kenaf and hemp are preferably used in the present invention.

In the vehicle and in other fields, it is often desired to provide components on a panel, and the molding of them in a single operation is often difficult, expensive (from a tool and assembly standpoints and others), and demolding can also be a problem. For example, using as an illustration and not as a limitation, door panels used in vehicles typically include a number of components for providing strength to the panel, for locating various items such as wire harnesses and the like, and for other purposes as will be illustrated in connection with the description of the preferred embodiment of the present invention. Prior practice has been to separately mold such components (which may be circular, rib-shaped, U-shaped or the like), and then to attach them at the appropriate location on the panel using adhesives or heat. It will be obvious from the description of this process that it is time consuming and expensive, and also increases the potential for mistakes.

One attempted solution is described in U.S. Pat. No. 5,506,029 issued Apr. 9, 1996 to Hara et al. and entitled “Fiber Reinforced Thermoplastic Resin Shaped Article.” In the Hara et al. process, a fiber reinforced thermoplastic resin shaped article is prepared from a preheated fiber reinforced resin sheet which is placed between upper and lower molds. The molds are prepared in such a way that a clearance is provided between them at the time the molds are clamped together, the clearance being larger than a thickness of the unpreheated fiber reinforced thermoplastic resin sheet. A liquid resin is supplied in molten form into cavities within the mold, and the thermoplastic is then integrated by fusion with a portion of the fiber reinforced sheet when it is heated. In other words, both the preparation of the panel and components attached thereto, such as ribs or bosses, occurs in the same mold and during the same operation.

The process of the above-referenced Hara et al. patent requires expensive tooling and careful control of the molding operations due to the clearances which are normally not desired in a molding of products.

A method of making panels having components attached thereto in an economical and efficient manner, and the product which would result from such a process would represent substantial improvements in this art.

### FEATURES AND SUMMARY OF THE INVENTION

A primary feature of the present invention is to provide a panel having components attached thereto, the components and panel being made from separate materials.

Another feature of the present invention is to provide a panel and a method for adding components thereto by injection molding.

A different feature of the present invention is to provide a panel which includes natural fibers and/or thermoplastic material and adding components thereon by injection molding.

A further feature of the present invention is to provide a method for placing components on a surface of a panel which is quicker and less costly than applying the components by the use of adhesives or heat.

A still further feature of the present invention is to provide a panel having components thereon which are securely attached to the panel.

Another feature of the present invention is to reduce the product weight of panels by providing localized reinforcement of backside features.

Yet another feature of the present invention is to eliminate show-through of backside features onto the A-surface (the show or front surface) of a panel.

With respect to the method, a feature of the invention is to combine the functions of a die-trim and an injection-molding tool in the invention's preferred embodiment.

Another feature of the invention is to increase flexibility in panel design, while reducing overall system cost.

Yet another feature of the present invention is to reduce cycle time for panel fabrication by eliminating the need to add separate backside pieces, thereby reducing labor and part variation.

How these and other features of the present invention are accomplished individually, collectively, and in various subcombinations will be described in the following detailed description, taken in conjunction with the FIGURES. Generally, however, they are provided by molding onto a surface of a panel components such as doghouses, bosses, ribs, locators and the like, preferably after the panel has been initially thermoformed. The components are preferably made from a glass-filled thermoplastic material, such as polypropylene. The resulting panels with features show high bond strength and reduced tooling costs and time compared to prior processes. In its most preferred embodiment, the process involves forming a panel in a mold, cooling the panel and loading it to a trim tool following, which a press is, closed and held in place while molten plastic is injected through gates and runners. The heated plastic is cooled, the press is opened and the part is removed. Also in the most preferred embodiment, graphics may be imprinted on the “A” surface during the initial panel molding process, while different features are subsequently provided on the back surface. This aspect of the invention will be illustrated in connection with an audio feature described in greater detail below. Other ways in which the above and additional features are accomplished will become apparent to those skilled in the art after they have read the present specification. Such other ways are deemed to fall within the scope of the present invention if they fall within the scope of the claims which follow.

### BRIEF DESCRIPTION OF THE FIGURES

In the following FIGURES, like reference numerals are used to indicate like components, and

FIG. 1 is a side elevation view of the inner surface of a vehicle door trim panel showing certain components molded thereon;

FIG. 2 is a side elevation view of a different vehicle door trim panel showing a variety of components molded to the inner surface thereof;

FIG. 3 is a perspective and illustrative view of the back side of a panel, showing components and the molding runners associated therewith;

FIG. 3A is a perspective view of the molding system used to prepare the panel and molded components shown in FIG. 3;

FIG. 4 is a process flow chart for preparing a panel with injection molded components according to a preferred embodiment of the present invention; and

FIG. 5 is a perspective view of the “A” surface of a trim panel which includes a graphic feature imprinted thereon.

### DETAILED DESCRIPTION OF THE PREFERRED EMBODIMENT

Before proceeding with the detailed description of the preferred embodiment, several general comments can be made about the applicability and the scope of the present invention.

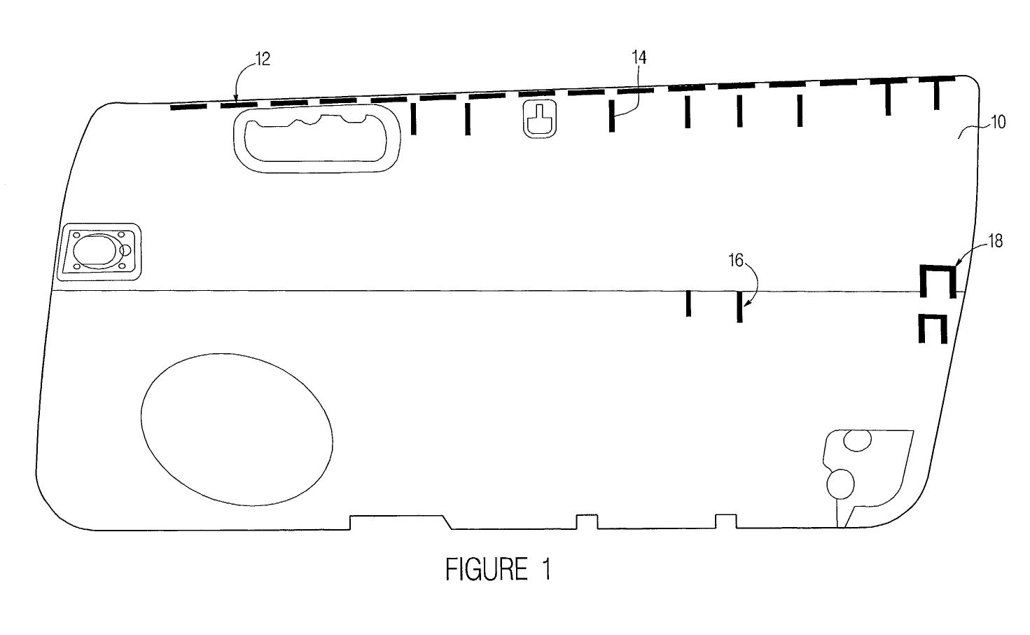

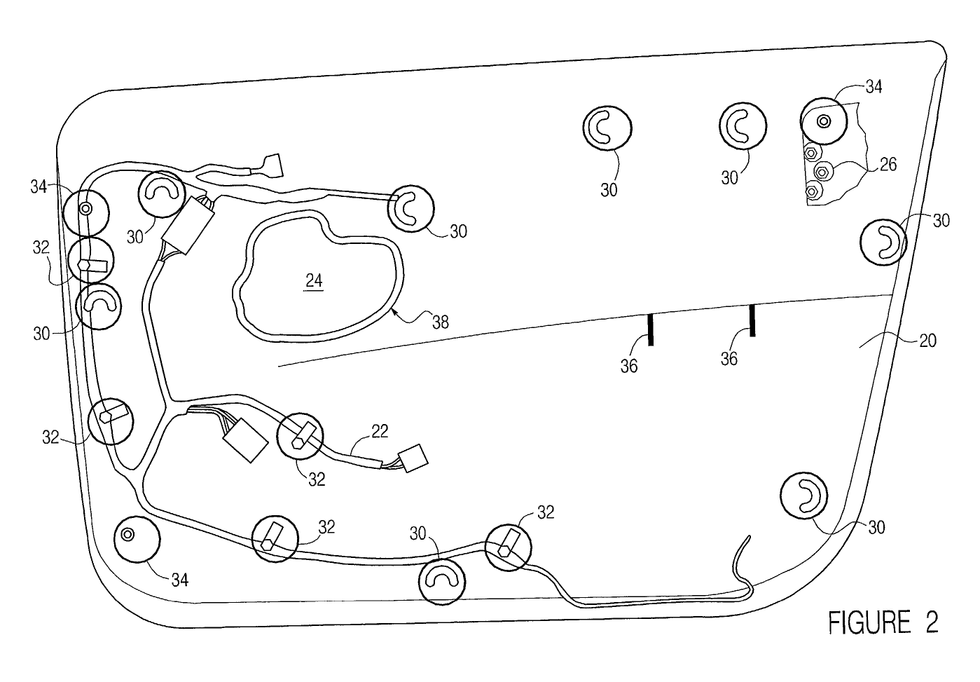

First, two illustrative door trim panel systems are illustrated in FIGS. 1 and 2 to indicate the wide variety of components and locations with which the present invention may prove useful. The particular trim panels and the particular location and type of components can vary widely. For example, there may be more or fewer components than actually illustrated, and all need not be attached using the present invention. For example, the trim panel may include one or more molded components using the present invention and other components added by more conventional processes, such as the use of adhesives.

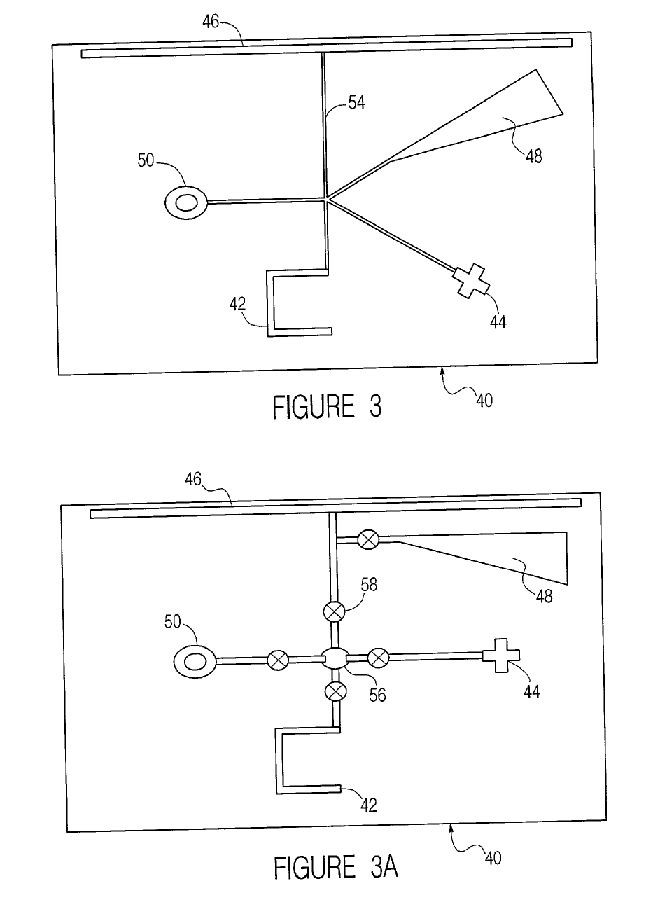

FIG. 3 is shown for purposes of illustrating the runners which will be present on the inner or “B” surface of a panel after removal of the part from the molding press. Again, the particular components shown in this FIGURE are solely for purposes of illustration.

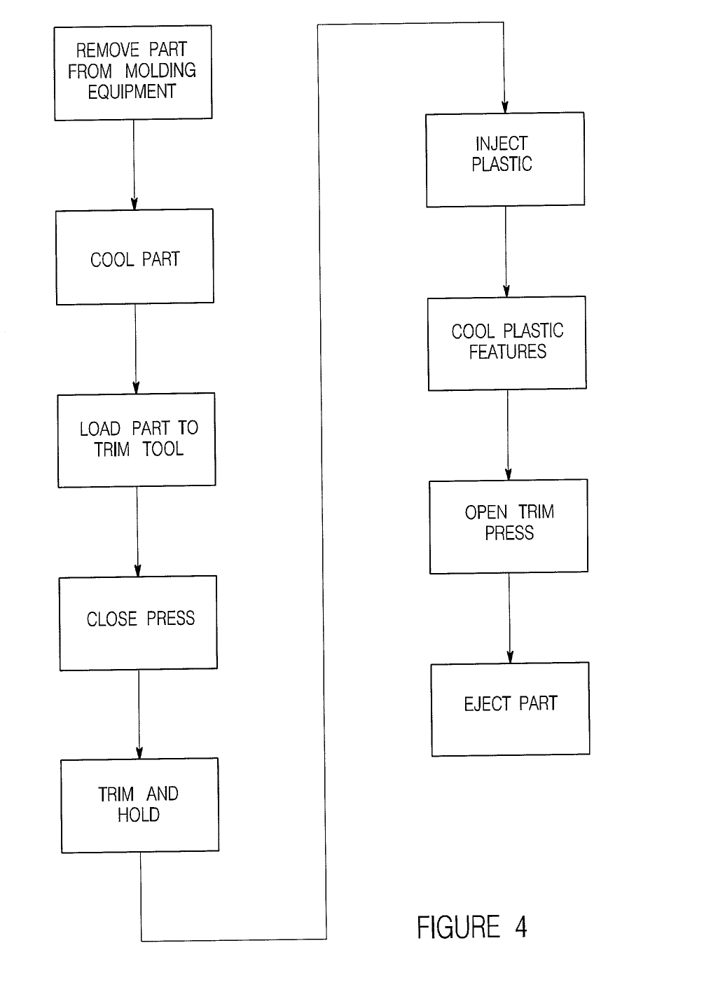

In connection with the process described in the flow chart of FIG. 4, it will note that the trim panel is initially formed and then cooled prior to providing molded components thereon in a trim press. The process may be variously embodied to eliminate the cooling step, using a separate trim press and trimming process prior to the injection molding of components in a different piece of equipment, or all processes could be carried out, in sequence, in the same tool.

While the preferred material for use in forming the components in the present invention is polypropylene, other injection molding plastics, including filled materials, may be readily substituted by those skilled in the art. Several criteria are that the resulting component provide sufficient robustness for its intended purpose, that the component remain in its hardened state throughout the temperature range to which the component may be exposed, and that the component have a melt temperature sufficiently low to prevent damage to the panel.

In the preferred embodiment, the trim panel itself includes natural or synthetic fibers which present a surface capable of mechanically bonding to a melted thermoplastic resin, or a thermoplastic material which may include recovered and ground PET headliner material from the recycling process of automotive vehicles, e.g., a panel such as that described in the aforementioned '802 patent. The thermoplastic panels will form a fusion bond with components. There is no requirement that recycled materials be used in either the component or the panel, but the obvious benefits flowing from the use of recycled materials makes them attractive for use in the present invention. These include cost, environmental benefits, and the like.

The number of injection ports, gates and runners are also widely variable depending upon the particular panel and the number of components to be molded thereagainst. In FIG. 3, for example, five components are shown. A system involving a single gate and five shut-off valves is illustrated in FIG. 3A.

Finally, the present specification will describe a further feature which may be derived from the present invention, i.e., the imprinting of a feature on the surface of the trim panel opposite to that which will receive the molted components. For example, this feature could be used in a headliner system to draw an occupant's attention to audio components, while the “B”, back or inside of the headliner trim panel could include the mounting for the speakers to be associated therewith. This particular example is meant to illustrate the principles involved, rather than to serve in any way as a limitation on the type of component which may be imprinted on the interior, show or “A” side of the trim panel or the location thereof.

Continuing now with the description of the preferred embodiment and alternates therefor, FIG. 1 shows the present invention to include a door trim panel 10 which, as mentioned before, may be a vehicle panel such as that described in the aforementioned '802 patent. Several components which may be found on a typical door trim panel have been eliminated for purposes of simplifying the description here. In the illustrated panel 10, certain components are molded on the “B” surface, i.e., the surface facing the viewer of the FIGURE. Examples of components which may be added to panel 10 according to the present invention and using an injection molding process, include down turned flanges 12 which extend along the top of the panel. Ribs 14 are also located at the top and are generally perpendicular to flanges 12. They are used to stabilize the top edge of panel 10 after installation. A pair of ribs 16 is located in the armrest area to provide support therefor, and a pair of doghouses 18 are shown on the right side of the FIGURE, these doghouses being generally U-shaped in the illustration.

A more comprehensive use of the present invention is shown with another panel 20 in FIG. 2. Panel 20 is preferably made using natural fibers. This panel shows a wire harness 22 extending to various locations on panel 20, a speaker opening 24, and other components which have been added to panel 20, either at the time of its manufacture or by fasteners such as is illustrated at reference numeral 26. The encircled areas indicate components or features which are injection molded to the “B” surface of panel 20 using the present invention. A plurality of doghouses are illustrated at reference number 30; a plurality of wire harness attachment components are shown at 32; and a plurality of locator pegs are shown at 34. In addition, FIG. 2 shows two ribs 36 in the general area of the armrest. Finally, a speaker enclosure wall 38 is shown surrounding the speaker opening 24. It should be clearly understood that the particular components, their location, and the number will vary widely depending on the particular door product, its components (structural, electrical, convenience, etc.) and that the FIGURE is for purpose of illustrating the fact that a variety of different components can be molded to the surface of panel 20, using the present invention.

For purposes of illustrating the present invention in a more simplified form, a specimen panel 40 is illustrated in FIG. 3, together with five components: a doghouse 42, a cross 44, an elongate rib 46, a tapered plate 48, and a boss 50. FIG. 3 is instructive because it also shows the runners 54 which extend from a central hub 56 to the individual components 42-50. The preferred thermoplastic resin for the components is polypropylene. Glass filling can be used to provide additional strength to the components.

Reference to FIG. 3A will assist in understanding how the molten resin is applied to panel 40 to form the components 42-50. This panel 40 was prepared to illustrate component variability and was also used to test the bond between the components and panel 40. The tapered plate 48 and the cross 44 were particularly useful in such tests. Also shown in FIG. 3A is the gate 56 used for the injection of the molten thermoplastic resin, as well as a plurality of shut-offs 58 which can be used to prevent the flow of molten resin to any of the particular components. One skilled in the injection-molding art will readily appreciate the construction of tooling to include such gates and shut-offs for different injection-molded components.

Proceeding now to FIG. 4, the most preferred process of the present invention is illustrated in a flow diagram. In this FIGURE, the starting point is the removal of a trim panel from the equipment used to mold or thermoform it. The process continues by cooling the part and subsequently loading it into a trim tool press. The press is closed, the part is trimmed and then held in a closed position while the injection plastic is added to form the components. The resin is allowed to cool, following which the trim press is opened, and the part, including panel and added components, is removed. In most operations, the part will be inspected, trimmed if necessary, and placed into inventory or added to the end use product.

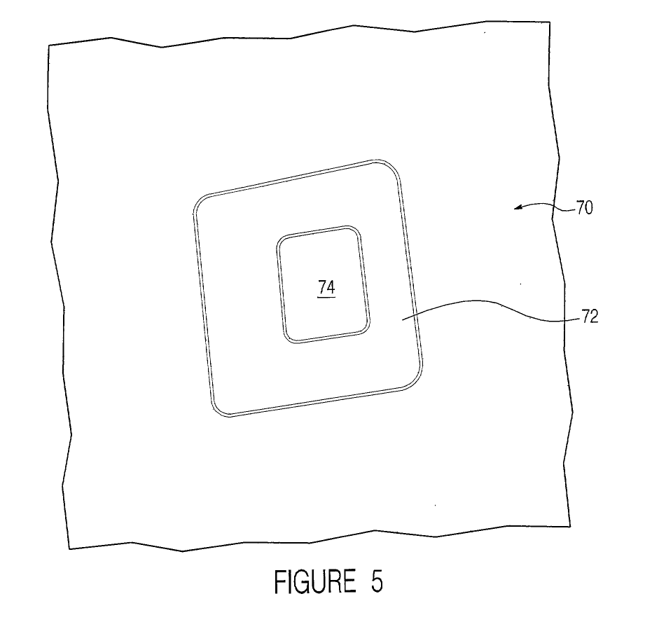

FIG. 5 shows another feature of the present invention, i.e., the imprinting onto a panel 70 of a graphic design 72, illustrated here to be a square having an open center 74. The process of the present invention allows the imprinting of the design 72 on the “A” surface of the panel in the original thermoforming equipment, while backside features or components, such as speakers or components totally unrelated to the graphic design can be placed on the inside or “B” surface, without bleed through.

As discussed above, the primary goals of the present invention are to eliminate the need to inventory and manually apply components by conventional processes such as the use of heat or adhesives. The ability to mold components on the backside of a panel, without there being any bleed-through onto the “A” surface, is another significant advantage, as is providing secure bonds between the components and panel's “B” side. Product weight can be reduced, due to the ability of the present invention to provide localized reinforcement, or the ability to eliminate the number of parts required.

While the present invention has been described in connection with a preferred embodiment and an exemplary sample, the present invention is not to be limited thereby, but is to be limited solely by the scope of the claims which follow.

What is claimed is:

1. A panel system comprising:
a panel comprising a surface adapted to bond to heated thermoplastic resin; and
at least one component adhered to the panel surface by a process which comprises molding a heated thermoplastic resin in the shape of each component against the surface and allowing the heated thermoplastic resin to cool.

2. The panel system of claim 1, wherein the panel includes at least some thermoplastic resin.

3. The panel system of claim 2, wherein the thermoplastic resin comprises polypropylene.

4. The panel system of claim 3, wherein the thermoplastic resin comprises a glass fiber-filled polypropylene resin.

5. The panel system of claim 1, wherein the panel includes natural or synthetic fibers.

6. The panel system of claim 1, wherein the panel includes at least some reclaimed material.

7. The panel system of claim 6, wherein the panel includes at least some reclaimed vehicle headliner.

8. The panel system of claim 1, wherein the panel is a vehicle trim panel, the surface is the “B” side of the trim panel and the trim panel also includes an “A” surface adapted to face the vehicle interior.

9. The panel system of claim 8, wherein the trim panel is selected from the group consisting of door, instrument panel, side, headliner, storage or floor trim panels.

10. The panel system of claim 8, wherein each component is selected from the group consisting of locating, reinforcing, attaching, surrounding, supporting or fastening components.

11. The panel system of claim 8, wherein each component is selected from the group consisting of ribs, doghouses, studs, rings, locators, and flanges.

12. The panel system of claim 8, wherein a graphic design is located on the “A” surface of the panel.

13. The panel system of claim 1, wherein the panel is formed by thermoforming, and the component is molded against the panel after the panel is thermoformed.

14. The panel system of claim 1, wherein the panel comprises at least some reclaimed vehicle trim material, and each component molded against the panel comprises a polyalkylene thermoplastic resin.

15. A method for preparing a panel having a first surface and at least one component located thereon comprising the steps of:
thermoforming a panel;
subsequently molding the at least one component against the first surface in the desired shape from a molten thermoplastic resin; and
allowing the molten thermoplastic resin to cool sufficiently to allow demolding thereof.

16. The method of claim 15, wherein the panel is cooled following thermoforming and prior to the molding of components thereon.

17. The method of claim 15, wherein each component is injection molded against the first surface.

18. The method of claim 17, wherein the injection molding step comprises injecting molten thermoplastic resin into a mold arranged to simultaneously form a plurality of components on the first surface.

19. The method of claim 15, wherein the molten thermoplastic resin is molten polypropylene.

20. The method of claim 19, wherein the molten thermoplastic resin is a molten glass fiber filled polypropylene resin.

21. The method of claim 15, wherein the material used to thermoform the panel fuses and bonds with the molten thermoplastic resin during the component molding step.

22. The method of claim 15 comprising forming a graphic design on a second surface of the panel.

23. The method of claim 15, wherein each component is selected from the group consisting of locating, reinforcing, attaching, surrounding, supporting or fastening components.

24. The method of claim 15, wherein each component is selected from the group consisting of ribs, doghouses, studs, annular rings, locators, and flanges.
